(19) United States
(12) Patent Application Publication
(10) Pub. No.: US 2005/0232292 A1
(43) Pub. Date: Oct. 20, 2005

(54) Transmission efficiency for broadcast/multicast services in cellular networks

(76) Inventors: Derek J. Richards, Swindon (GB); Peter J. Legg, Swindon (GB)

Correspondence Address: MORRISON & FOERSTER LLP, 755 PAGE MILL RD, PALO ALTO, CA, 94304-1018, US

(21) Appl. No.: 10/826,461

(22) Filed: Apr. 16, 2004

(51) Int. Cl. H04L 12/56; H04Q 7/00

(52) U.S. Cl. 370/432; 370/390

(57) ABSTRACT

Methods, systems and apparatus are provided for determining whether or not to provide a multicast service in a first cell of a mobile radio network using information provided by one or more UEs in the network. For example, a network may enable a multicast service in a first cell if a number of UEs, determined to be positioned in neighbouring cells and requesting the multicast service in the first cell, is larger than a threshold value.

### CROSS-REFERENCE TO RELATED APPLICATIONS

Not applicable.

### BACKGROUND OF THE INVENTION

1. Field of Invention

The present invention relates to multicast and simulcast communication services provided in a mobile radio network, and more particularly to signalling messages transmitted between a base station and user equipment for establishment of multimedia broadcast multicast services (MBMS).

2. Description of Related Art

Mobile radio networks originally were designed to provide efficient point-to-point communications. For example, early cellular networks provided a voice connection between a mobile transceiver and another mobile transceiver or a landline phone. More recent mobile radio networks supplemented point-to-point capabilities with broadcast services. A broadcast service may be provided with a cell broadcast channel. A cell broadcast channel allows a network to broadcast information to all mobiles and user equipment (UE) positioned within a cell, where a cell is a coverage area created by a base station's transceiver.

Broadcast information carried on a cell broadcast channel may include location-based information such as local sports, weather and traffic conditions and/or may include network-wide services such as national news headlines and stock updates. This broadcast information in, for example, a Global System for Mobile communications (GSM) network, is limited to text based messages. A mobile phone user may elect which categories of cell broadcast information will be displayed on the user's mobile phone.

Members of the 3rd Generation Partnership Project (3GPP) have proposed enhancements to Universal Mobile Telecommunications System (UMTS) networks. The proposed enhancements include an incorporation of multicast services and related features. A multicast is a broadcast capable of being transmitted by a group of base stations in a mobile radio network. A service may contain multimedia content. A multicast service is an information transmission that may be directed to a group of UEs in a network. Thus, proposed UMTS networks would provide for broadcasts and multicasts of both text and multimedia over groups of cells.

Multicast services are transmitted from one or more base stations in a mobile radio network. Multicast services may be directed to a specific UE by a base station transmitting a point-to-point signal. Multicast services may be directed to a group of UEs by a base station transmitting a point-to-multipoint signal. For example, in a first cell, the radio resources may be more efficiently used by having a base station provide a multicast service to each UE via separate point-to-point links, one link for each UE. In a second cell, it may be more efficient to have a base station provide the multicast service to all UEs requesting the service via a single point-to-multipoint transmission. In a cell with a base station transmitting a point-to-multipoint signal, all of the UE receiving the multicast service monitor the same point-to-multipoint link.

It may be desirable to provide a system for enabling multicast services, determining in which cells to enable a multicast service and selecting between point-to-point and point-to-multipoint transmission modes. Additionally, when determining whether to enable a multicast service in a first cell, it may be desirable to consider the needs of UEs located in neighbouring cell. Moreover, it may be desirable to facilitate combining of point-to-multipoint links by UEs in neighbouring cells with services provided in a first cell even when no UEs are positioned in the first cell or when any UEs use point-to-point links in the first cell.

Additional information regarding the proposed UMTS standards and recommendations further detailing multicast and MBMS features may be found on the 3GPP website. The 3GPP website provides relevant recommendations and standards including 3GPP TR 25.992: “Multimedia Broadcast Multicast Service (MBMS); UTRAN/GERAN Requirements”; 3GPP TS 22.146: “Multimedia Broadcast/Multicast Service; Stage 1”; 3GPP TS 22.246: “MBMS User Services; Stage 1”; 3GPP TS 23.246: “Multimedia Broadcast Multicast Service; Architecture and Functional Description”; 3GPP TS 25.331: “Radio Resource Control (RRC) protocol specification”; and 3GPP TS 25.346 “Introduction of the Multimedia Broadcast Multicast Service (MBMS) in the Radio Access Network (Stage 2)”.

### SUMMARY OF THE INVENTION

Methods, systems and apparatus are provided for determining whether or not to provide a multicast service in a first cell of a mobile radio network using information provided by one or more UEs in the network. For example, a network may enable a multicast service in a first cell if a number of UEs, determined to be positioned in neighbouring cells and requesting the multicast service in the first cell, is larger than a threshold value.

Some embodiments provide a method for determining whether to initiate a multicast service from a first base station of a first cell, the method comprising: receiving a user message transmitted by user equipment positioned in a second cell, wherein the first cell is a neighbour of the second cell, and wherein the user message includes a list of one or more neighbouring cells; and in response to the user message, initiating the multicast service in the first cell, wherein the first cell is listed in the list of one or more neighbouring cells.

Some embodiments provide a method for determining whether to initiate a multicast service in a group of cells in a network, the method comprising: receiving one or more user messages transmitted by a respective one or more user equipment positioned in the group of cells in the network, wherein each one or more user messages includes a list of one or more neighbouring cells; and for each cell of the group of cells, accumulating a first count of the user messages having the cell included the list of one or more neighbouring cells; and initiating the multicast service in a cell if the first count for the cell is not zero.

Some embodiments provide a method to assist in determining whether to initiate a multicast service within a mobile radio network, wherein user equipment is positioned in a first cell of a first base station having a group of neighbouring cells, the method comprising: determining, for each neighbouring cell in the group of neighbouring cells, whether the user equipment can detect the neighbouring cell; generating a user message indicating which of the neighbouring cells the user equipment can detect; transmitting the user message; and receiving a network message generated responsive to the user message, wherein the network message indicates a new transmission of the multicast service by a second base station in a second cell; wherein the second cell is indicated in the user message.

Some embodiments provide a mobile radio system for providing a multicast service, the system comprising: a network including a first base station creating a first cell; a plurality of second base stations creating a respective plurality of second cells; a plurality of third base stations creating a respective plurality of third cells; and a memory including accumulated data; wherein second cells are neighbours of the first cell and the third cells are not neighbours of the first cell; and a plurality of user equipment each positioned in one cell of the first, second and third cells; wherein the accumulated data represents user equipment determined to be positioned in the first cell and user equipment determined to be positioned in one of the second cells.

Some embodiments provide a method of signalling between user equipment and a network across an air interface, wherein the user equipment is positioned in a first cell created by a first base station, wherein a set of neighbouring base stations create a respective set of neighbouring cells, and wherein the first base stations transmits on a downlink and the user equipment transmits on an uplink, the method comprising: signalling, on the downlink, a first list of all neighbours of the first base station; signalling, on the downlink, an initiation of a counting procedure for a multicast service; signalling, on the uplink, a second list including an indication of acceptable cells from the first list.

Some embodiments provide a method of requesting a multicast service by user equipment in a first cell, wherein the first cell created by a first base station, and wherein the first base station has a group of neighbouring cells created by a respective group of neighbouring base stations, the method comprising: determining, for one or more of the neighbouring cells, whether a signal from the respective neighbouring base station is receivable by the user equipment; creating a first list from the receivable neighbouring cells; generating a user request message, wherein the user request message includes a request for a multicast service and the first list of received neighbouring cells; and transmitted the user request message from the user equipment to the first base station.

Some embodiments provide a method to initiate a multicast service in a group of cells neighbouring a first cell, the method comprising: transmitting a network message to initiate a response from user equipment in the first cell; receiving a user message transmitted by the user equipment positioned in the first cell; and in response to the user message, initiating the multicast service in the group of cells neighbouring the first cell.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

FIG. 1 illustrates a group of UEs positioned in a network having a first cell and six neighbouring cells.

FIG. 2 illustrates conventional signalling used to request and establish a multicast service.

FIG. 3 illustrates conventional signalling used to inform a UE in a first cell of its neighbour cells.

FIG. 4 illustrates signalling used to request and establish a multicast service in accordance with some embodiments of the present invention.

FIG. 5 illustrates signalling used to provide a network with updated cell combining information in accordance with some embodiments of the present invention.

FIG. 6 illustrates signalling used to provide a network with updated cell combining information in accordance with some embodiments of the present invention.

### DETAILED DESCRIPTION OF THE PREFERRED EMBODIMENTS

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

Some portions of the detailed description that follow are presented in terms of procedures, steps, logic blocks, processing, and other symbolic representations of operations on data bits that can be performed on computer memory. A procedure, computer executed step, logic block, process, etc., are here conceived to be a self-consistent sequence of steps or instructions leading to a desired result. The steps are those utilizing physical manipulations of physical quantities. These quantities can take the form of electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

A multicast service, unlike broadcast services, is directed to one or more specific UEs. A service may include more than just short text messaging, such as multimedia content containing audio and/or video. The content may range in length from a short clip (e.g., a 15-second news clip) to a long presentation (e.g., a two-hour long movie). The content may be transmitted once or periodically. Content periodically transmitted may be updated with time. For example, the content may be news clips updated and transmitted at the top of the hour. The content may be images, software, executables, music or videos that are downloaded in non-real-time (e.g., overnight) and may be used later by a UE in real-time. Furthermore, the content may be a continuous stream of audio, video and/or textual data much like a radio broadcast, a television station broadcast or a ticker tape. Additionally, this information may be advertising, on-demand services, full-length movies, movie clips and trailers, audio broadcasts, public announcements, emergency alerts, service announcements, radio station retransmissions and the like.

The proposed enhancements support an establishment of a point-to-point and a point-to-multipoint multicast links transmitted from base stations to LJEs in the network. When a multicast service is transmitted by a base station to UEs with point-to-point links, each UE in a cell uses a separate point-to-point link. Each point-to-point link is established as the link is needed. When a multicast service is established with a point-to-multipoint link, all of the UEs in a cell share the same point-to-multipoint link. When a new UE in a cell requests the multicast service in the cell having an established point-to-multipoint link, there is no need to create a new link.

To determine whether a network should have a base station initiate a multicast service using a point-to-point or a point-to-multipoint link, the network may count the number of UEs desiring the multicast service in each cell. If radio resources are available and a sufficient number of UEs desire a particular service in a particular cell, the network may initiate a point-to-multipoint link. If radio resources are available and a small number of UEs desire a particular service in a particular cell, the network may establish a point-to-point multicast link for each UE in the cell. If no UEs desire a particular service in a particular cell, the network may not transmit the multicast service in that particular cell.

Some network architectures allow a UE to combine downlink signals. A downlink signal is a signal transmitted across the air interface by a base station to a UE. A UE may be able to receive a desired multicast service from multiple base stations. When a UE is in a location where it receives downlink signals from multiple base stations transmitting the same multicast service, the UE may use combining techniques, such as selective combining or maximum-ratio combining, to effectively improve reception of information.

Combining techniques are especially useful when a UE is located at an edge of a cell or straddling two or more cells. Combining techniques, such as maximum-ratio combining and selective combining, may be less useful when a UE is very close to the base station's transmitter. In such cases, a satisfactory quality of service (QoS) may be obtained with signals from a single base station and therefore the UE may elect not to employ combining techniques.

Maximum-ratio combining may be used with mobile radio networks that are synchronised at the physical layer. That is, maximum-ratio combining may occur if transmissions from a first base station are bitwise aligned with transmissions of a second base station. A UE may combine one or more layer 1 (L1) frame transmissions at the physical layer from each base station. A UE may re-combine or add together L1 frames using a function which weights the received signals based on a signal-to-noise ratio (SNR) of each received signal. For example, the combining function may give more weight to signals which have higher SNR values.

Selective combining may be used in unsynchronised networks. If a network is not synchronised at the L1 level (i.e., base stations are not bitwise aligned), transmissions may be combined by the UE at the layer 2 (L2) level. In selective combining, a UE receives, demodulates and buffers signals of one or more L2 frames with a common L2 sequence number from multiple base stations. The UE then selects the one L2 sequence that is deemed the best (e.g., having the lowest number of detected CRC errors or lowest block error rate).

Maximum-ratio combining may produce a better QoS result than provided by selective combining but maximum-ratio combining can only be used in bit aligned synchronised networks. Typically, selective combining may be used in either an unsynchronised or synchronised network. Additionally, selective combining may be used in networks using either time-division duplex (TDD) or frequency-division duplex (FDD) modulation. Maximum-ratio combining may be limited to synchronised TDD networks.

For example, in a TDD network that facilitates a UE's use of maximum-ratio combining, a multicast service may be transmitted on a point-to-multipoint link in a first cell on timeslot t₁. The TDD network may repeat that service in a neighbouring second cell on a point-to-multipoint link on a different timeslot, for example, timeslot t₂. Furthermore, the TDD network may repeat that service again in a neighbouring third cell on a point-to-multipoint link on yet another timeslot, for example, timeslot t₃. A UE positioned in the particular cell may determine that L1 performance is such that it should combine the timeslot t₁ signal from the first cell with signals in timeslots t₂ and/or t₃ of respective neighbouring second and third cells. By combining the signals from two or more point-to-multipoint transmissions carried on different timeslots from respective base stations, a UE may improve the reliability of a multicast service.

A UE may only combine a received point-to-multipoint transmissions from a first cell with received point-to-multipoint transmissions from neighbouring cells carrying the same multicast service. Some counting procedures may determine whether to provide a service in a first cell by counting only those UEs located within the first cell. The presence of UEs in neighbouring cells may not affect the determination of whether to provide the service and how to provide the service in the first cell.

Conventional multicast network architectures may not optimise a QoS a UE could obtain. For example, a multicast networks that consider a single UE as located, and therefore counted, in just one cell may unnecessarily reduce a QoS a UE could obtain. On the other hand, a multicast network that considers or anticipates an ability of a UE to combine signals received from one or more neighbouring cells may transmit additional signals in neighbouring cells so that the UE may perform combining.

A network that provides a point-to-multipoint link carrying a multicast service in a neighbouring cell allows a UE to combine its local point-to-multipoint signal with signals from the neighbouring cell. By allowing a IJE to exploit combining techniques, its QoS may increase. Furthermore, a UE exploiting combining techniques may allow base stations to transmit signals at a lower power level while still providing a sufficient QoS.

Additionally, a network that anticipates a UE's transition from one cell to the next may also reduce or eliminate interruptions due to mobility of the UE. For example, if a UE is using a point-to-multipoint link and travels to a new (neighbouring) cell, continuity of a multicast service may depend on the availability and the speed at which the network can establish the multicast service in the new cell. If the new cell is already transmitting a point-to-multipoint signal in anticipation of the UE's arrival, the network may reduce or eliminate setup times required to establish a new point-to-point multicast service in the new cell.

One solution may be to enable and transmit all possible multicast services in all cells, even if no UE requests the multicast service and even if no UE is located in a cell. A multicast service would be available to any UE requesting the service. An alternate solution, which on the average uses a lower base station transmit power, is to provide multicast services in each cell of a network but to limit the transmitted services to only those multicast services being requested and consumed by one or more UEs somewhere in the network.

Another solution, provided by some embodiments of the invention, transmits a multimedia service in cells and neighbouring cells where a multicast service is being consumed by one or more UEs. In a first group of cells, each cell contains one or more UEs that are consuming a multicast service. A second group of cells consists of cells that are neighbours to the first group of cells. Each base station in a union of the groups of cells transmits the multicast service, such that any UE consuming a service is in a cell having neighbours also transmitting the multicast service. If the base station of each neighbouring cell transmits a point-to-multipoint signal, a UE is free to combine signals if it so desires. Additionally, a transition from a cell in the first group of cells to a neighbouring cell may avoid a typical delay associated with a network establishing the multicast service on a new link in the new cell. The first and second groups of cells may be updated by a network periodically or in response to certain triggers or events, such as a detection of a UE moving from a first cell to a second cell.

In some embodiments of the invention, a point-to-multipoint signal is initiated in neighbouring cells of a UE where the network anticipates that the UE will actually use or will probably use the neighbouring multicast signals for combining. For example, a UE may transmit a signalling message to the network that reports a signal measurement, such as a received beacon power, from a first cell and/or from one or more neighbouring cells. A network may compare the signal measurement to a threshold value and may determine that a reporting UE is positioned in a fringe area between two or more cells. The network may determine that radio resources are available and the reporting UE will benefit by establishment or continuation of one or more transmissions of a particular multicast service in one or more neighbouring cells. The reporting UE may then detect the presence of or be signalled that a neighbouring transmission is available in the one or more neighbouring cells. The UE may then benefit by combining the multiple downlink signals.

Some embodiments of the invention initiate a multicast transmission in neighbouring cells after receiving a request from a UE. For example, a UE consuming a multicast service may determine that it could combine multicasts signals if a particular neighbouring cell began transmitting the multicast service. The UE may generate and transmit a signalling message to the network requesting activation of the service in one or more of its neighbouring cells. In some embodiments of the invention, a UE may detect the subsequent enabling of the multicast service in in neighbouring cells. In some embodiments of the invention, the network may signal the UE that a newly initiated multicast service is available in one or more neighbouring cells. In some embodiments of the invention, either a UE consuming a multicast service with a point-to-point link or the network may determine that switching from the point-to-point link to a point-to-multipoint link in the first cell would allow it to combine the first cell's signal with detected point-to-multipoint signals from neighbouring cells. A network may switch from a point-to-point link to a point-to-multipoint link by beginning to announce or signal that the link is a multipoint link. Alternatively, a network may perform a handover or the like from an established point-to-point link to a new point-to-multipoint link.

Embodiments of the present invention are described below in greater detail with reference to the figures.

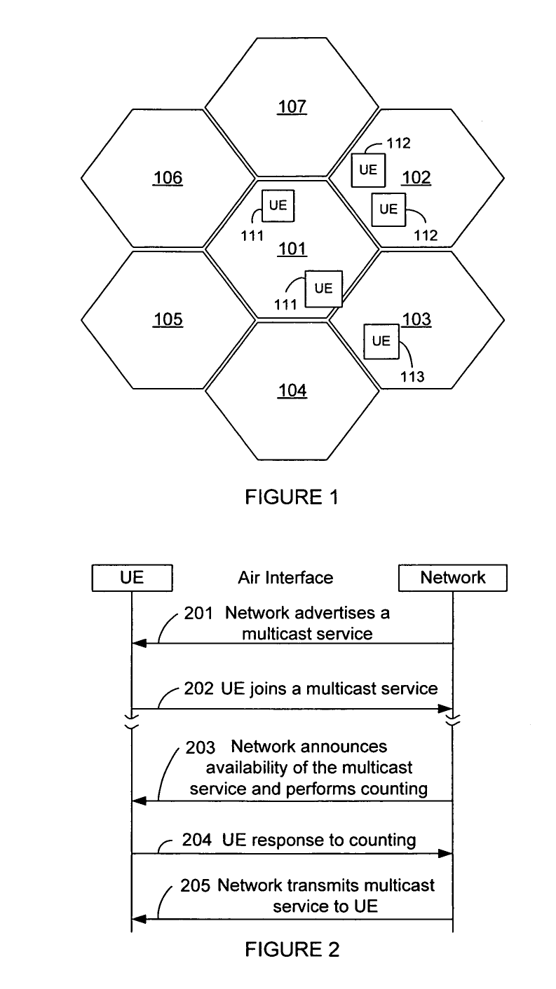

FIG. 1 illustrates a group of UEs 111, 112, 113 positioned in a network having a first cell 101 and neighbouring cells 102-107. Each cell 101-107 may be created by a transmission from a respective base station (not shown). Networks may offer multicast services, UEs may request multicast services, networks may provide requested multicast services, and UEs may consume multicast services. A network may request that UEs provide information about neighbouring cells. A UE may provide a list of neighbouring cells. These may be cells that a UE could use for combining or may be cell into which the UE may travel. A UE may also provide a list of signal measurements respectively associated with the listed neighbouring cell. Generally, a signal measurement may be an indication of received power and/or of signal quality. For example, a signal measurement may be a value indicative of received beacon signal power, received pilot signal power, an error rate, a block error rate, a CRC result, a CRC error count, a block error count, a signal-to-noise ratio, or the like.

If UEs 111, 112, 113 have not requested a multicast service, the network may not transmit the service from any of the base station. If UE 113 requests a multicast service, the network may determine that the service should be offered in just cell 103. In the request for service, the UE may include a list of one or more cells that it could use for combining if a service was offered in the listed cell. The UE may also include a list of signal measurements corresponding to the list of cells.

For example, UE 113 may determine that no neighbouring cells to cell 103 may be strong enough for combining. Alternatively, UE 113 may determine that cell 104 could be combined with its cell 103. UE 113 may optionally make a signal measurement of the signal from cell 104. UE 113 may then include the list of cells (cell 104) and, optionally, the corresponding signal measurement (measurement of cell 104). If UE 113 were straddling cells 101, 103 and 104, it may determine than it may combine its signal from cell 101 with signals from either or both cells 101 and 104. UE 113 may optionally make a signal measurement of the signal from cells 101 and 104. Based on the signal measurements, UE 113 may then transmit the list of cells (cells 101 and 104) and, optionally, transmit the corresponding signal measurements (measurement of cells 101 and 104).

The message from the UE to the network may optionally contain a signal measurement from the cell where the UE is located. For example, UE 113 may make a measurement of the received power from cell 103 or make a measurement of the received power of a multicast service transmitted by the base station in cell 103.

The network may use the information received from UE 113 to determine in which cells to offer the requested multicast service. For example, the network may initiate the service in each cell that UE 113 reported that it could use for combining. Alternatively, the network may initiate the service in a cell having the best signal measurement reported by UE 113. Alternatively, the network may initiate the service in up to a set number of cells or in cells having a sufficient signal measurement reported by UE 113.

Assuming that the network allocated a point-to-point link in cell 103 for UE 113, the link maybe changed in the future. For example, if one UE 111 in cell 101 requests the same service, the network may follow one of the procedures described above. The network may determine that the base station of cell 101 should transmit the service requested by UE 111. If UE 111 reported that it would combine the service from cell 101 with the service from cell 103, if available, the network may initiate a point-to-multipoint link in cell 101, thus allowing UE 111 to receive the service. The network may also change the transmission mode in cell 103 from a point-to-point link to a point-to-multipoint link. The network may inform UEs 111 & 113 that the multicast service is available in a neighbouring cell. That is, the network may signal UE 111 that the service is available for combining from neighbouring cell 103. Similarly, the network may signal UE 113 that the service is available for combining from its neighbouring cell 101.

The process of adding more services for requesting UEs may continue. With each request the network may determine whether to facilitate combining by activating a requested service in neighbouring cells to the cell where the UE is positioned. The multicast transmissions may continue as long as there is a UE in the cell or a neighbouring cell consuming the service.

A reverse process may be used such that radio resources are continually managed by the network. In such cases, a network may determine that a radio resource may be better utilized if the service was turned off in a cell if no UEs in the cell were consuming the service. If the service is turned off in the cell, it will no longer be available for combining by UEs in neighbouring cells. Similarly, if a single UE is using a point-to-multipoint link and no neighbouring UEs need the link, the network may switched over the point-to-multipoint link to a point-to-point link. The process of evaluating radio resources in a network may be performed continuously, periodically and/or bases on triggering events.

A network may use the measurement response message to determine whether to continue or discontinue an existing point-to-point or point-to-multipoint link. Alternatively, the network may decide to enable a new point-to-multipoint link. If the network decides to continue a multicast service on the present link, it may adjust power levels of its transmitted signals. If the network decides to discontinue a multicast link to provide more efficient use of resources, it may need to enable one or more point-to-point links then instruct a subset of UEs to migrate to the new links. If the network decides to enable a new point-to-multipoint link in a cell, it may instruct a subset of UEs to migrate from old point-to-point links to the new link.

A network and a UE may exchange messages across an air interface. Messages from the network may be broadcast via the cells base station to all UEs in a cell, to a group of UEs, or to a single UE. For each cell in a network, the network may transmit to UEs in the cell a list of neighbouring cells. UEs that are idle and not connected to the network may receive the neighbouring list information on a multicast control channel or the like. Similarly, UEs that are presently connected to the network (connect mode UEs) may receive the neighbouring cell information on a multicast control channel. New or updated neighbouring cell information may be provided to connect mode UEs when information changes in the lists.

FIG. 2 illustrates conventional signalling used to request and establish a multicast service between a UE and a network. The network initially advertises one or more multicast services with message 201.

The advertisement may be for a multicast service that is immediately available, periodically available or available at some time in the future. For example, the network may advertise a football match that will begin broadcasting at a set time. If a user desires to receive the multicast service, the UE selects and joins the multicast service with message 202. The network may then authenticate the UE and records that a UE wants the multicast.

The requested multicast service may be currently in-progress (e.g., being broadcast to other UEs) or it may be available to the UE on demand or at some time in the future. Once a service is available, the network sends a message 203 that announces the availability of the multicast service. The network also initiates a counting procedure to request that UEs not known by the network respond for counting. In message 204, the UE responds to the counting request. UEs already known by the network may not need to respond to the counting with message 204. For example, the network already is aware of the presence of UE in connect mode with the network. The network may not know the location of idle mode UEs though. Therefore, idle mode UEs, which may drift from cell to cell unknown to the network, may need to respond to the network's counting request. The network uses the counting results to determine in which cells to begin the service. If not already transmitting, the network instructs the base station of the cell where the UE is located to begin transmitting the service.

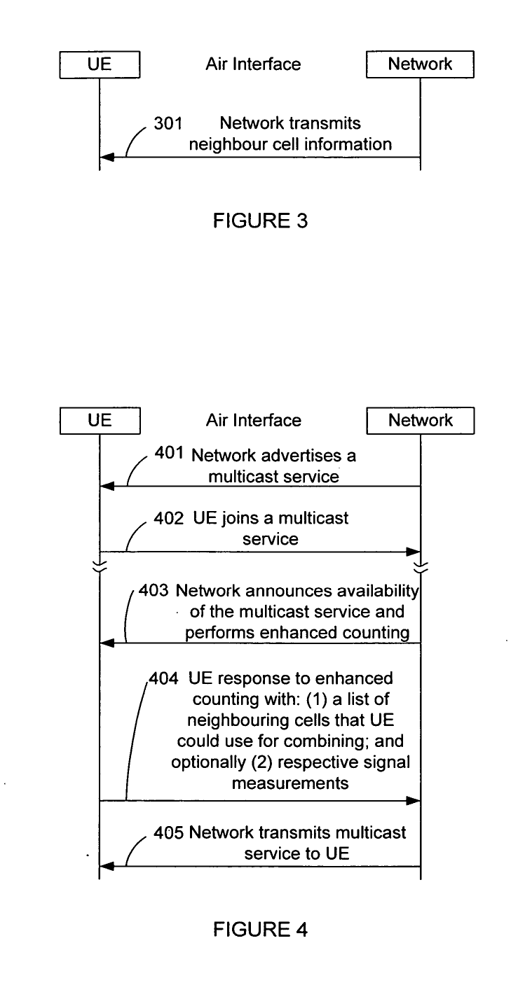

FIG. 3 illustrates conventional signalling used to inform a UE in a first cell of information regarding its neighbouring cells. The message 301 may contain each of the neighbours of the first cell. For example, referring to FIG. 1, base station in cell 101 may broadcast on an overhead channel or may transmit directly to a connected UE a list containing cells 102 to 107. A base station in cell 107 may send a list containing cells 101, 102 and 106, and so on. A UE may use the neighbouring cell information to check which base stations signals are available for combining.

FIG. 4 illustrates signalling used to request and establish a multicast service between a UE and a network in accordance with some embodiments of the present invention. The network initially advertises one or more multicast services with message 401. If a user desires to receive the multicast service, the UE selects and joins the multicast service with message 402. The network may then authenticate the UE and records that a UE wants the multicast.

Once a service is available, the network sends a message 403 that announces the availability of the multicast service. The network also initiates an enhanced counting procedure. The enhanced counting procedure requests UEs not known by the network that want the available service to respond for counting.

In an enhanced counting, a UE develops a list of neighbours that could potentially be used for combining if the base station in that neighbouring cell broadcast the service. If not already determined by the UE, the UE checks each neighbouring base station identified in message 301. The UE determines whether the base station may be combined with the signal from the cell in which it is positioned. In some embodiments, the UE also makes a signal measurement for either each cell listed in messages 301 or each cell listed as a candidate for combining. In message 404, the UE responds to the enhanced counting message 403 with a list of neighbouring cells that the UE could use for combining. In some embodiments, the UE also provides a respective signal measurement for each neighbouring cell listed. In some embodiments, the UE also provides a signal measurement of the cell in which the UE is located. This list of neighbours may be generated by the UE in response to a request from the network, or may be generated automatically by the UE, e.g., in response to an event or on a periodic schedule.

In some embodiments, the list of cell information message may contain one or more types of neighbouring cell lists, for example, Lists A and/or B and/or C. List A contains a list of all neighbouring cells of the current cell. List B shows a list of neighbouring cells capable of providing a multicast service if that service were to be requested by a UE in that cell or a neighbouring cell. List C contains a list of neighbouring cells presently transmitting a multicast service. Lists A, B and C may be combined, grouped or may be separate lists. The lists may be transmitted within a single neighbouring cell information message, may be separated into separate neighbouring cell information messages, or may be attached to other messages transmitted in the network.

Using neighbouring cell information, a UE may determine which neighbours (e.g., from list A, B or C described above) could provide a sufficient signal to the UE for combining. To do so, a UE may attempt to measure a signal measurement of each neighbour cell base station (list A).

Alternatively, a UE may attempt to measure a signal measurement of each neighbour capable of providing a service but not presently providing the service (list B). In addition or alternatively, the UE may attempt to measure a signal measurement of a point-to-multipoint signal of neighbouring cells presently providing the multicast service (list C).

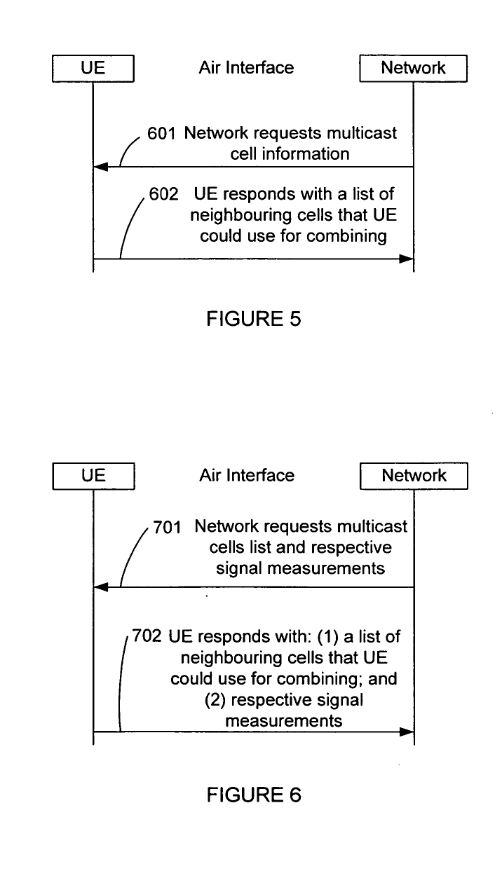

Similarly, a UE in a connect mode with the network is inherently counted, however, the network may not know which neighbouring cells the UE may uses for combining. Enhanced counting procedures with respect to connect mode UEs is described below with respect to FIGS. 5 and 6.

The network may use messages 404 (that contain a list of neighbours for combining) from a plurality of UE to count a number of UEs in a first cell and to count a number of UEs in neighbouring cells to the first cell. The network makes a determination of whether to start a multicast service in a first cell based on at least the number of UEs in neighbouring cells to the first cell. Similarly, the network may use messages 404 (that contain both a list of neighbours for combining and respective signal measurements) from a plurality of UE to determine whether to start a multicast service in a first cell base on signal measurements of UEs in neighbouring cells to the first cell. Each time the network receives a signal measurement, the network may adjust transmit power of the links. Additionally, each time the network enables or disables a link, the network may update its cell information provided to the UEs.

In some embodiments, if the network does not have an existing point-to-multipoint link enabled and the network has a resource available to allocate, it must determine whether to allocate a point-to-point link or a point-to-multipoint link. If no other UEs are receiving the multicast service in the cell, the network may allocate a point-to-point link. If a small number of UEs are receiving the multicast service on point-to-point links in the cell, the network may allocate another point-to-point link. If the number of UEs receiving the multicast services reaches a threshold number, the network may activate a point-to-multipoint link in the cell and instruct each UE to change over to the new point-to-multipoint link. Once the UEs have changed over, the point-to-point links may be torn down. The network may also set the power level of the new point-to-point link or new point-to-multipoint link based on UE and system requirements.

In message 405, the network transmits the requested multicast service to the UE. The network determines whether the service is transmitted via a point-to-point link. The network also determines whether to initiate the service in cells neighbouring the cell in which the UE in positioned.

FIG. 5 illustrates signalling used to provide a network with updated cell combining information in accordance with some embodiments of the present invention. A network inherently knows the position of a UE in connect mode with the network. The network, however, does not know information about the UE's ability to combine signals from one or more neighbouring cells with a signal from its cell. In message 601, the network requests multicast information for enhanced counting from the UE.

If not already determined by the UE, the UE checks each neighbouring base station identified in message 301. The UE determines whether the base station may be combined with the signal from the cell in which it is positioned. In message 602, the UE-responds to message 601 with a list of neighbouring cells that the UE could use for combining. In some embodiments, the UE also provides a signal measurement of the cell in which the UE is located.

FIG. 6 illustrates signalling used to provide a network with updated cell combining information in accordance with some embodiments of the present invention. As described with reference to FIG. 5, network inherently knows the position of a UE in connect mode with the network but may not know information about the UE's ability to combine signals from one or more neighbouring cells with a signal from its cell.

In message 701, the network requests multicast information for enhanced counting from the UE. The network requests both a list of cells that the UE could use for combining and also a list of respective signal measurements.

If not already determined by the UE, the UE checks each neighbouring base station identified in message 301. The UE determines whether the base station may be combined with the signal from the cell in which it is positioned. The UE also makes a signal measurement for either each cell listed in messages 301 or each cell listed as a candidate for combining. In message 702, the UE responds to message 701 with a list of neighbouring cells that the UE could use for combining and a respective signal measurement for each neighbouring cell listed. In some embodiments, the UE also provides a signal measurement of the cell in which the IJE is located.

Once a multicast service is established by the network, a UE may be requested by the network to provide measurements. The request may be made by signalling with a measurement request message. Alternatively, the measurements may be provided periodically or may be provided once an event has occurred. Such an event may be that a received power level of a neighbouring cell increased or decreased a threshold amount.

A UE may transmit a measurement response message to the network. The response message may include an indication of received power and/or signal quality of the current cell. The response message may include an indication of received power and/or signal quality of the neighbouring cells, for example, from lists A, B and/or C.

In some embodiments of the present invention, a UE may initiate a request for a multicast service by sending a multicast service request to a base station servicing the UE's cell. For a UE in idle mode, the UE may first need to establish a basic connection to the network using a random access channel or the like. A UE in connect mode may send the multicast service request message without establishing a new connection. The multicast service request message may be a separate message or may be a message attached or embedded in another message.

Once a network receives the multicast service request, a network must determine whether it has an available resource to honour the request. If a point-to-multipoint link has previously been established for another UE in the same cell, the network may respond to the request with a multicast service response message thereby assigning the UE to the existing point-to-multipoint link. The network may adjust the power level of the point-to-multipoint link to reflect system and UE requirements.

As previously described, the network may determine whether to provide the requested service. If a new service is to be allocated, the network decided whether to allocate a point-to-point or a point-to-multipoint link. For example, if a UE requests a point-to-multipoint link in the current cell and two neighbouring cells, the network may need to determine whether to switch existing point-to-point UEs to point-to-multipoint links in the different cells. Based on resource availability, the network may determine that some but not all of the requested point-to-multipoint links will be provided or enabled. The network may adjust power on existing links and may determine an initial power level on new links. The network may then reply to the UE's request with a multicast service response message. The response may include link information and which requested channels are allocated to point-to-multipoint service.

The figures provided are merely representational and may not be drawn to scale. Certain proportions thereof may be exaggerated, while others may be minimized. The figures are intended to illustrate various implementations of the invention that can be understood and appropriately carried out by those of ordinary skill in the art.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

1. A method for determining whether to initiate a multicast service from a first base station of a first cell, the method comprising:
receiving a user message transmitted by user equipment positioned in a second cell, wherein the first cell is a neighbour of the second cell, and wherein the user message includes a list of one or more neighbouring cells; and
in response to the user message, initiating the multicast service in the first cell, wherein the first cell is listed in the list of one or more neighbouring cells.

2. The method of claim 1, further comprising:
transmitting, in the second cell from a second base station, a network message to request the user equipment positioned in the second cell to provide neighbouring cell information;
wherein the user message is in response to the network message.

3. The method of claim 1, wherein the list of one or more neighbouring cells is a list of neighbouring cells the user equipment could use for combining if the multicast service is initiated in the listed neighbouring cell.

4. The method of claim 1, wherein the list of one or more neighbouring cells indicates base stations that the user equipment could use for combining if the multicast service is transmitted by the indicated base station.

5. The method of claim 1, wherein the list of one or more neighbouring cells indicates base stations that the user equipment could use for combining.

6. The method of claim 1, wherein the list of one or more neighbouring cells indicates base stations having transmissions that the user equipment is able to demodulate.

7. The method of claim 1, wherein the list of one or more neighbouring cells indicates base stations having transmissions that the user equipment is able to demodulate.

8. The method of claim 1, wherein the list of one or more neighbouring cells indicates base stations having transmissions that the user equipment is able to detect.

9. The method of claim 1, wherein the user message further includes a signal measurement for each cell in the list of one or more neighbouring cells.

10. The method of claim 9, wherein the signal measurement is indicative of one or more of a signal quality, an error rate, a received signal power level, or a signal-to-noise ratio.

11. The method of claim 9, wherein the signal measurement is indicative of a beacon signal power.

12. The method of claim 9, wherein the signal measurement is indicative of a pilot signal power.

13. The method of claim 9, wherein the signal measurement is indicative of signal power of an existing multicast transmission.

14. The method of claim 1, further comprising the act of transmitting from a second base station in the second cell, an initial message to indicate to the user equipment a list of cells that are neighbours to the second cell.

15. The method of claim 1, further comprising the act of transmitting from a second base station in the second cell, an initial message to wake the user equipment positioned in the second cell from an idle mode.

16. The method of claim 15, wherein the initial message is a page notification message including a set of indicators corresponding to a respective set of multicast services, and wherein each of the indicators indicates whether the second base station is transmitting an updated multicast control channel message.

17. The method of claim 2, wherein the network message includes a cause value that indicates an enhanced counting procedure is invoked for the multicast service.

18. The method of claim 1, further comprising the act of allowing the user equipment to join the multicast service.

19. A method for determining whether to initiate a multicast service in a group of cells in a network, the method comprising:
receiving one or more user messages transmitted by a respective one or more user equipment positioned in the group of cells in the network, wherein each one or more user messages includes a list of one or more neighbouring cells; and
for each cell of the group of cells, accumulating a first count of the user messages having the cell included the list of one or more neighbouring cells; and
for each cell of the group of cells, initiating the multicast service in the cell if the first count for the cell is not zero.

20. The method of claim 19, further comprising:
for each cell of the group of cells, accumulating a second count of the user messages received from user equipment in the cell; and
initiating the multicast service in a cell if the second counter for the cell is not zero.

21. The method of claim 20, wherein the act of includes initiating the multicast service in a cell if the second counter for the cell is not zero:
initiating a point-to-point multicast service in the cell if a sum of the first count and second count is less than a threshold number; and
initiating a point-to-multipoint multicast service in the cell if the sum of the first count and second count is greater than the threshold number.

22. The method of claim 19, wherein the act of initiating the multicast service in a cell if the first count for the cell is not zero includes:
initiating a point-to-point multicast service in the cell if the first count is less than a threshold number; and
initiating a point-to-multipoint multicast service in the cell if the first count is greater than the threshold number.

23. A method to assist in determining whether to initiate a multicast service within a mobile radio network, wherein user equipment is positioned in a first cell of a first base station having a group of neighbouring cells, the method comprising:
determining, for each neighbouring cell in the group of neighbouring cells, whether the user equipment can detect the neighbouring cell;
generating a user message indicating which of the neighbouring cells the user equipment can detect;
transmitting the user message; and
receiving a network message generated responsive to the user message, wherein the network message indicates a new transmission of the multicast service by a second base station in a second cell; wherein the second cell is indicated in the user message.

24. The method of claim 23, further comprising:
receiving a first signal from the first base station transmitting the multicast service;
receiving a second signal from the second base station transmitting the multicast service; and
combining the first and second signals.

25. The method of claim 23, wherein a base station transmission that the user equipment can detect may be combined if the multicast service in enabled on the base station.

26. The method of claim 23, wherein a base station transmission that the user equipment can detect can provide the user equipment with at least a minimum level of service.

27. The method of claim 23, further includes the act of:
determining a signal measurement for each of the neighbouring cells;
wherein the user message further includes the signal measurement for each of the neighbouring cells.

28. The method of claim 23, further includes the act of:
determining a signal measurement for each of the neighbouring cells that are detected;
wherein the user message further includes the signal measurement for each of the neighbouring cells that are detected.

29. The method of claim 28, wherein the signal measurement is indicative of a received beacon signal power.

30. The method of claim 28, wherein the signal measurement is indicative of a received pilot signal power.

31. A mobile radio system for providing a multicast service, the system comprising:
a network including
a first base station creating a first cell;
a plurality of second base stations creating a respective plurality of second cells;
a plurality of third base stations creating a respective plurality of third cells; and
a memory including accumulated data;
wherein second cells are neighbours of the first cell and the third cells are not neighbours of the first cell; and
a plurality of user equipment each positioned in one cell of the first, second and third cells;
wherein the accumulated data represents user equipment determined to be positioned in the first cell and user equipment determined to be positioned in one of the second cells.

32. The system of claim 31, wherein the accumulated data represents a count of user equipment determined to be positioned in the first cell, and a count of user equipment determined to be positioned in one of the second cells.

33. A method of signalling between user equipment and a network across an air interface, wherein the user equipment is positioned in a first cell created by a first base station, wherein a set of neighbouring base stations create a respective set of neighbouring cells, and wherein the first base stations transmits on a downlink and the user equipment transmits on an uplink, the method comprising:
signalling, on the downlink, a first list of all neighbours of the first base station;
signalling, on the downlink, an initiation of a counting procedure for a multicast service;
signalling, on the uplink, a second list including an indication of acceptable cells from the first list.

34. The method of claim 33, further comprising signalling, on the uplink, a third list including a signal measurement for each of the acceptable cells from the second list.

35. A method of requesting a multicast service by user equipment in a first cell, wherein the first cell created by a first base station, and wherein the first base station has a group of neighbouring cells created by a respective group of neighbouring base stations, the method comprising:
determining, for one or more of the neighbouring cells, whether a signal from the respective neighbouring base station is receivable by the user equipment;
creating a first list from the receivable neighbouring cells;
generating a user request message, wherein the user request message includes a request for a multicast service and the first list of received neighbouring cells; and
transmitted the user request message from the user equipment to the first base station.

36. The method of claim 35, wherein the act of creating a list from the receivable neighbouring cells includes:
determining whether the receivable signal is combinable by the user equipment; and
including in the first list an indication of cells determined to be combinable.

37. The method of claim 35, further comprising:
determining a signal measurement for each cell in the list of received neighbouring cells;
wherein the user request message further includes the signal measurement for each cell in the list of received neighbouring cells.

38. A method to initiate a multicast service in a group of cells neighbouring a first cell, the method comprising:
transmitting a network message to initiate a response from user equipment in the first cell;
receiving a user message transmitted by the user equipment positioned in the first cell; and
in response to the user message, initiating the multicast service in the group of cells neighbouring the first cell.
